(19) United States
(12) Patent Application Publication
(10) Pub. No.: US 2014/0339020 A1
(43) Pub. Date: Nov. 20, 2014

(54) OMNIDIRECTIONAL TREE STAND

(71) Applicant: Shaun Bradley, Norman, OK (US)

(72) Inventor: Shaun Bradley, Norman, OK (US)

(21) Appl. No.: 13/897,356

(22) Filed: May 17, 2013

(51) Int. Cl. A01M 31/02

(52) U.S. Cl. CPC A01M 31/02
USPC 182/187

(57) ABSTRACT

The invention is an omnidirectional tree stand.

### CLAIM OF PRIORITY

The invention is related to and claims priority from U.S. Provisional Patent Application No. 61/648,527 entitled OMNIDIRECTIONAL TREE STAND filed on May 17, 2012 having common inventor Shaun Bradley.

### TECHNICAL FIELD OF THE INVENTION

The present invention relates to sporting equipment, and more specifically to tree stands. More particularly still, the invention relates to climbing and hanging tree stands.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Tree stands are popular hunting equipment devices, or serve as observations points for bird/animal watching. Although there are several types of tree stands, predominantly two are related to the present invention—“climbing stands” and “hanging stands,” which are known to those of skill in the art.

Typically, two parts make up “climbing stands.” A bottom portion is a standing platform and a top portion has/is the seat with or without a seat back. Normally, a strap connects the two parts such that if the bottom falls while in the tree or climbing, the platform does not fall all the way to the ground thereby stranding the hunter.

Climbing tree stands typically use one of two methods to connect to a tree. The part that wraps around the tree can be made from a thick cable or boomerang shaped piece of metal. The part that wraps around the tree is fastened to the stand with a bolt or pin for easy adjustment for different tree sizes.

Before climbing the tree both parts need to be adjusted to the tree so they are level for the hunter to stand and sit on. To climb the tree the back of each part is angled to the tree one at a time and pulled up. Then, the part that the hunter is moving is set back level and the next part is moved up. This is done until the hunter is at the desired height. For safety, some hunters strap the tree stand to the tree.

Typically, “hanging stands” connect to the tree with chains or cables at the desired height. To get up to a hanging stand hunters use ladders or sections of ladders secured to the tree (called “climbing sticks”), or they use screw in steps that screw in the tree and allow the hunter to climb up to the stand.

However, finding a tree that a tree stand will work with is problematic. For climbing stands, one must find a tree that has no limbs up to the height desired for hunting. Additionally, for both climbing and hanging tree stands, a user must find a substantially vertical portion of a tree, which is problematic in many locations. Accordingly, what is needed is a tree stand that overcomes these limitations.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables.

FIG. 1 illustrates a tree-attachable frame.

FIG. 2 illustrates a platform frame.

FIG. 3 illustrates a close-up of an exemplary frame coupling system.

### EXEMPLARY BEST MODE

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way. Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### Description of the Drawings

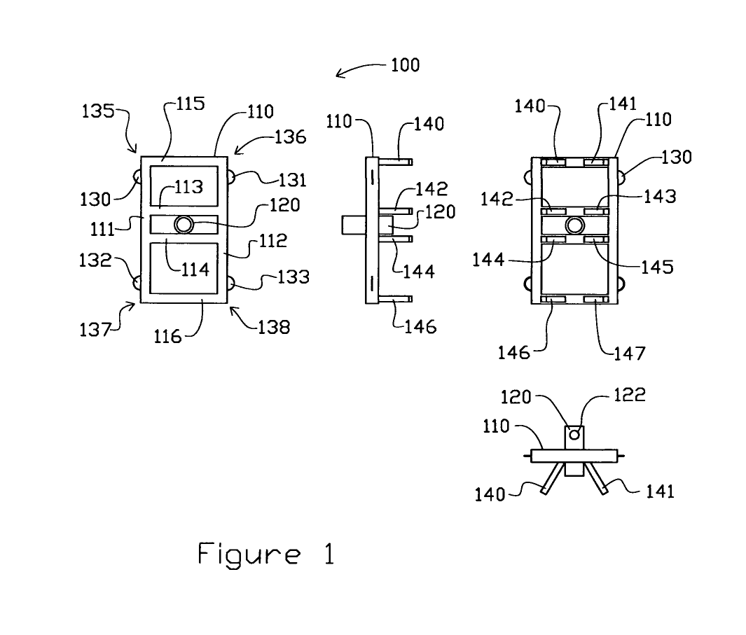

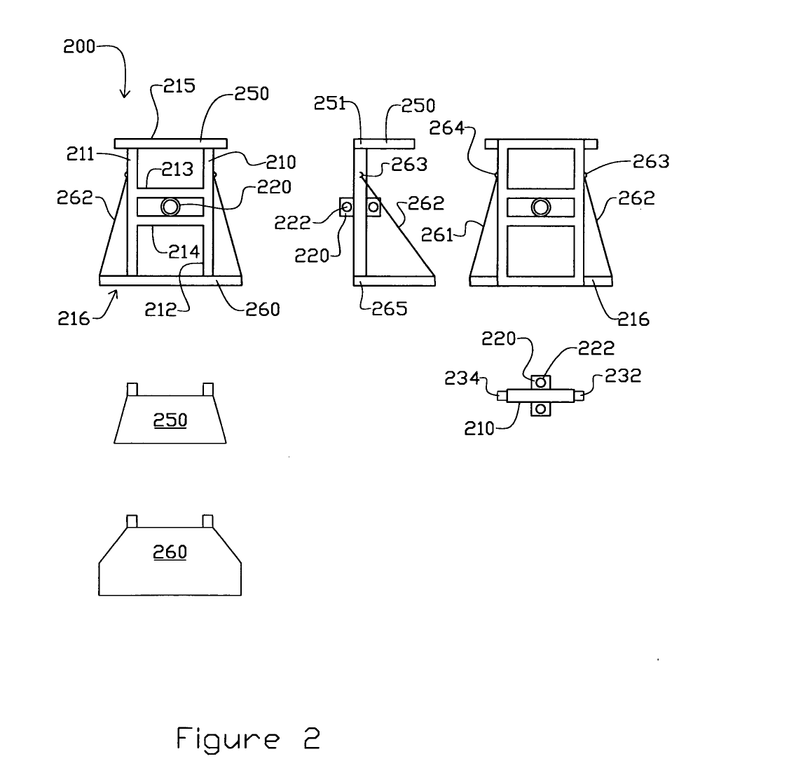

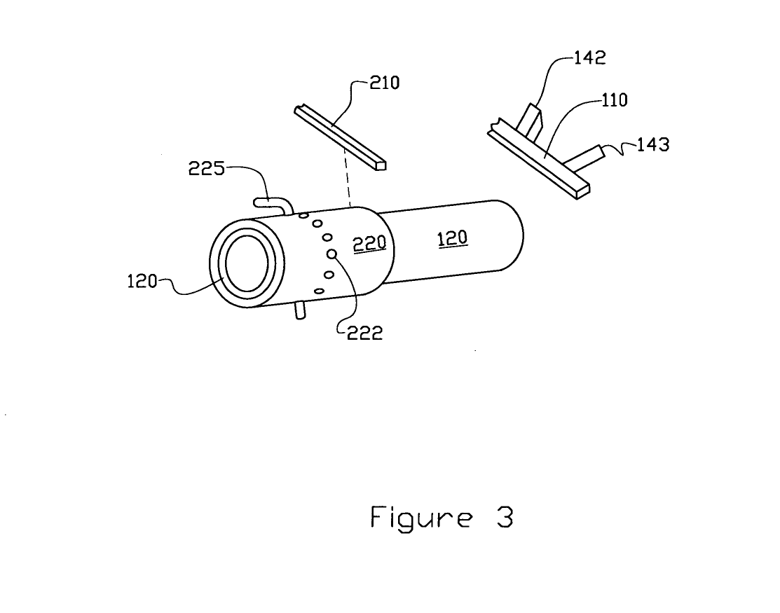

With simultaneous reference to the drawings, in which like numerals designate like parts, FIG. 1 illustrates a tree-attachable frame system 100, FIG. 2 illustrates a platform frame 200, and FIG. 3 illustrates a close-up of an exemplary frame coupling system 300. When combined, the tree-attachable frame 100, the platform frame 200, and the frame coupling system 300 define an omnidirectional tree-stand apparatus.

The apparatus includes a tree-attachable frame system 100 having a first vertical member 111 and a second vertical member 112, a first horizontal member 113 and a second horizontal member 114 such that the vertical and horizontal members meet in a substantially planar “H” shape which defines a first H-plane. The tree-attachable frame 110 also has a first tree coupling 130, which may be a band tree coupling, a cable coupling, or a metal tree-skirt coupling means, for example, attached to the first vertical member 111 at a first top position 135 and a corresponding second tree coupling 131 attached to the second vertical member 112 at a second top position 136, as well as a third tree coupling 132 attached to the first vertical member 111 at a first bottom position 137, and a corresponding fourth tree coupling 133 attached to the second vertical member 112 at a second bottom position 138. Also illustrated are a third horizontal member 115 and a fourth horizontal member such that the vertical members and the third and fourth horizontal member 116 which meet with the vertical members 111, 112 in a substantially rectangular shape. The tree-attachable frame 110 is preferably metallic, and sufficiently sized to attach to a tree capable of supporting the weight of an adult human.

The tree-attachable frame 110 also has a first frame coupling 120 rigidly attached thereto, preferably via both the first horizontal member 113 and the second horizontal member 114. The first frame coupling 120 is preferably cylindrical, such as a metal pipe, and preferably comprises holes 122 there-about, preferably at 15-degree angles, for example, although other hole-angels do not depart from the scope of the invention. Additionally, the tree-attachable frame 110 further includes a first pair of frame stabilizers 142, 143 coupled to the first vertical member 113, the frame stabilizers 142, 143 positioned in a substantially planar “V” pattern relative to each other and protruding away from the first H-plane at a substantially perpendicular angle. Also illustrated are a third, fourth, fifth, sixth, seventh and eighth frame stabilizers, 140, 141, 144, 145, 146, 147, respectively. Of course, it is understood that many equivalent stabilization systems exist and may be used with the invention.

The invention also includes platform frame system 200, including a platform frame 210 having a first vertical member 211 and a second vertical member 212, a first horizontal member 213 and a second horizontal member 214 such that the vertical and horizontal members meet in a substantially planar “H” shape which define a second H-plane.

The platform frame 210 preferably has a platform 260 rotatably and/or pivotably coupled to a horizontal member, such as the fourth horizontal member 216, and the platform frame 210 has a second frame coupling 220 rigidly attached thereto preferably between first horizontal member 213 and second horizontal member 214. Further, the shown platform frame 210 also has a third horizontal member 215 and a fourth horizontal member 216 such that the vertical members 211, 212 and the third and fourth horizontal members 215, 216, respectively, meet in a substantially rectangular shape.

The platform frame 210 also includes a seat 250 which is rotatably and/or pivotably coupled to the platform frame 210. The seat 250 and the platform 260 are supported via platform pivots 212, 214 which are enable pivotable attachment to the platform frame 210 via hinges 251, 265. Additionally, the platform 260 is further supported via platform support wires 261, 262 which couple to the platform frame 210 at support wire attachments 263, 264.

Preferably, the first frame coupling 120 and the second frame coupling 220 are cylindrical and rotatably attachable to each other, and either will be of a larger or smaller diameter of each other to enable them to be rotatably coupled to each other. Each of the preferred first frame coupling 120 and the second frame coupling 220 have a plurality of holes 122, 222 there-through which correspond with each other to enable the frame couplings to mate via a rod 225. Alternatively, the first frame coupling and the second frame coupling could be implemented via equivalents to enable fixated, rotatable, couplings, such as a ratchet coupling.

In operation, a user can first attach the tree-attachable frame system 100 to a tree, and then couple the platform frame system 200 to the tree-attachable frame system 100 in a way that allows for the platform 260 and/or the seat 250 to be substantially more horizontal and usable than in any existing tree stands.

Though the invention has been described with respect to a specific preferred embodiment, many advantages, variations and modifications will become apparent to those skilled in the art upon reading the present application. It is therefore the intention that the appended claims and their equivalents be interpreted as broadly as possible in view of the prior art to include all such variations and modifications.

I claim:

1. An omnidirectional tree-stand apparatus, comprising:
a tree-attachable frame having a first vertical member and a second vertical member, a first horizontal member and a second horizontal member such that the vertical and horizontal members meet in a substantially planar “H” shape which defines a first H-plane;
the tree-attachable frame having thereupon a first tree coupling attached to the first vertical member at a first top position and a corresponding second tree coupling attached to the second vertical member at a second top position, as well as a third tree coupling attached to the first vertical member at a first bottom position, and a corresponding fourth tree coupling attached to the second vertical member at a second bottom position;
the tree-attachable frame having a first frame coupling member rigidly attached thereto;
the tree-attachable frame having a first pair of frame stabilizers coupled to the first vertical member, the frame stabilizers positioned in a substantially planar “V” pattern relative to each other and protruding away from the first H-plane at a substantially perpendicular angle;
a platform frame, the platform frame having a first vertical member and a second vertical member, a first horizontal member and a second horizontal member such that the vertical and horizontal members meet in a substantially planar “H” shape which define a second H-plane;
the platform frame having a platform coupled to a horizontal member;
the platform frame having a second frame coupling member rigidly attached thereto;
the first frame coupling and the second frame coupling being rotatably attachable to each other.

2. The apparatus of claim 1 wherein tree coupling is a band tree coupling.

3. The apparatus of claim 1 wherein the tree coupling is a cable coupling.

4. The apparatus of claim 1 wherein the tree coupling comprises a metal tree-skirt coupling means.

5. The apparatus of claim 1 wherein the frame has a third horizontal member.

6. The apparatus of claim 5 wherein the frame has a fourth horizontal member.

7. The apparatus of claim 1 wherein the platform is rotatably coupled to the platform frame.

8. The apparatus of claim 1 wherein the seat is rotatably coupled to the platform frame.

9. The apparatus of claim 1 wherein the first frame coupling is a cylinder having a plurality of holes formed thereabout.

10. The apparatus of claim 9 wherein the second frame coupling is a cylinder having a plurality of holes formed thereabout.

11. The apparatus of claim 7 wherein the first frame coupling and the second frame coupling define a ratchet.

12. The apparatus of claim 1 wherein the first frame coupling is a cylinder and the second frame coupling is a cylinder.

13. The apparatus of claim 12 wherein the first frame coupling cylinder has a diameter greater than the second frame coupling cylinder.

14. The apparatus of claim 12 wherein the second frame coupling cylinder has a diameter greater than the first frame coupling cylinder.

15. The apparatus of claim 1 wherein the first frame coupling and the second frame coupling are rotatably attached to each other.

16. An omnidirectional tree-stand apparatus, comprising:
a tree-attachable frame having a first vertical member and a second vertical member, a first horizontal member and a second horizontal member such that the vertical and horizontal members meet in a substantially planar “H” shape which defines a first H-plane;
a third horizontal member and a fourth horizontal member such that the vertical members and the third and fourth horizontal members meet in a substantially rectangular shape;
the tree-attachable frame having thereupon a first tree coupling attached to the first vertical member at a first top position and a corresponding second tree coupling attached to the second vertical member at a second top position, as well as a third tree coupling attached to the first vertical member at a first bottom position, and a corresponding fourth tree coupling attached to the second vertical member at a second bottom position;
the tree-attachable frame having a first frame coupling rigidly attached thereto, the first frame coupling being a cylinder having a plurality of holes formed thereabout;
the tree-attachable frame having a first pair of frame stabilizers coupled to the first vertical member, the frame stabilizers positioned in a substantially planar “V” pattern relative to each other and protruding away from the first H-plane at a substantially perpendicular angle;
a platform frame, the platform frame having a first vertical member and a second vertical member, a first horizontal member and a second horizontal member such that the vertical and horizontal members meet in a substantially planar “H” shape which define a second H-plane;
the platform frame having a platform coupled to a horizontal member;
the platform frame having a second frame coupling rigidly attached thereto, the second frame coupling being a cylinder having a plurality of holes formed thereabout, such that the first frame coupling holes align lineally with at least tow holes in the second frame coupling; and
the first frame coupling and the second frame coupling being rotatably attachable to each other.
